(19) United States
(12) Patent Application Publication
(10) Pub. No.: US 2005/0204287 A1
(43) Pub. Date: Sep. 15, 2005

(54) Method and system for producing real-time interactive video and audio

(75) Inventor: Chuan-Hong Wang, Taipei City (TW)

Correspondence Address: BIRCH STEWART KOLASCH & BIRCH, PO BOX 747, FALLS CHURCH, VA, 22040-0747, US

(73) Assignee: IMAGETECH CO., LTD

(21) Appl. No.: 11/124,098

(22) Filed: May 9, 2005

(30) Foreign Application Priority Data
Feb. 6, 2004 (TW) 093115864

(51) Int. Cl. G06F 17/00; G11B 27/00

(52) U.S. Cl. 715/716; 345/418; 715/500.1

(57) ABSTRACT

A method and system for producing real-time interactive video and audio is disclosed. An object image is firstly captured, and is then displayed on a screen. An item is selected from a menu, and accordingly a corresponding multimedia object or objects are also displayed. The object image and the selected multimedia object interact in such a manner that the interaction is displayed in real-time and is continuously recorded and saved.

### BACKGROUND OF THE INVENTION

1. Field of the Invention

The present invention generally relates to a method and system for producing video and audio, and specifically to a method and system for producing real-time interactive video and audio.

2. Description of the Prior Art

There is a trend towards the combination of personal computers and consumer electronic products due to the price reduction and the availability of the video and photographic devices, such as digital cameras, network video devices or cell phones capable of taking pictures. The contemporary applications of the video and audio multimedia are, however, largely restricted to the still image, that is, the shooting, storage, and management of the photographs, and associated image processing/synthesis. Similarly, regarding the moving pictures, the video and audio equipments are mainly used for recording, converting format of, playing back, and sometimes, transmitting the moving pictures in real time through communication network. Nevertheless, such usage does not take full advantage of the equipments. Although player's action could be integrated into some interactive games, the design of game scenario is greatly limited by the techniques and equipments, which vastly limits the content variation of games.

The special effects as sometimes seen on television programs belong to the professional field that requires specialized and expensive equipments. Moreover, it is usually a challenge for actors to act solely facing another party not existent, therefore making the video production difficult.

### SUMMARY OF THE INVENTION

In view of the foregoing, it is one object of the present invention to provide an easy-to-use method and system for producing real-time interactive video and audio.

It is another object of the present invention to provide means for adding special effects on the interactive video and audio.

According to one embodiment of the present invention, an object image is firstly captured by a capture module, and is displayed on the screen of a display module. Users choose one item from an interface menu, and accordingly a multimedia object or objects are displayed. The object image and the selected multimedia object interact in such a manner that the interaction is displayed in real-time and is continuously recorded and saved.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 schematically shows a real-time interactive video and audio system according to one embodiment of the present invention;

FIG. 2 shows the manipulation of the file structure according to one embodiment of the present invention;

FIG. 3 shows an exemplary schematic illustrating that a chosen virtual object is superimposed on the face portion of the live person image;

FIG. 4 shows another example illustrating how a live person interacts with a virtual object in real-time; and

FIG. 5 shows a flow chart according to one embodiment of the present invention.

### DESCRIPTION OF THE PREFERRED EMBODIMENT

Some exemplary embodiments of the invention will now be described in greater details. Nevertheless, it should be recognized that the present invention can be practiced in a wide range of other embodiments besides those explicitly described, and the scope of the present invention is expressly not limited except as specified in the accompanying claims.

A method and system for producing real-time interactive video and audio is disclosed, which includes a display, a computing machine including a processor, a memory and a program, and a capture device. The program provides media data and effect track script. The capture device captures an object image such as live person image or animal image. The program integrates the object image and media data through the process by the effect track script, resulting into composed media data, which is then displayed on the screen of the display. In the system according to the present invention, the media data include multimedia such as text, photograph, audio, video and animation, and the media data could be presented in the form of virtual objects, virtual characters, audio, video, animations or questions, which then interact with the object image.

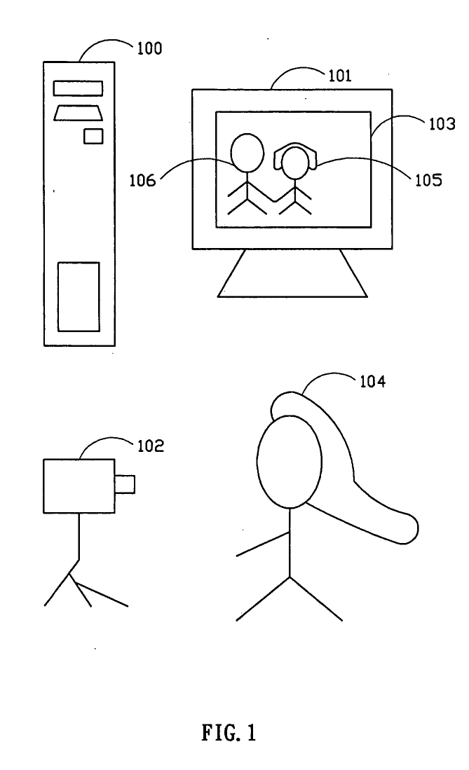

FIG. 1 schematically shows a real-time interactive video and audio system according to one embodiment of the present invention. This system includes a process module 100, a display module 101 and a capture module 102. In the embodiment, the process module 100 is a computing machine constituting of a processor and a memory, such as a personal computer, a set-top box, a game console, or even a cell phone. A host computer 100 is adopted to be the process module in present embodiment.

The display module 101 or the display, such as a cathode ray tube display, a liquid crystal display (LCD) or a plasma display, is connected to the process module 100 either by wire or wireless. The display 101 is mainly used to show the composed media data received from the process module 100. In the present embodiment, an LCD display 101 is adopted here. Besides, a web-camera (abbreviated as web-cam) 102 constituting the capture module 102, which is connected to the process module 100 by wire or wireless, is used for capturing the image of a live person 104. It is worth noting that, in the present embodiment, the process module 100 and the display module 101 could be joined together to form a single unit, such as a notebook computer or a tablet computer.

Referring again to FIG. 1, the web-cam 102 captures the image of the live person 104 standing in front of the web-cam 102, and the display 101 shows the resultant real-time image 105 on the screen 103 of the liquid crystal display 101. In the present specification, the term real-time is used in a sense that the live person image 105 reflects the variation of the live person 104 almost at the same time, and is shown immediately on the screen 103. Also shown on the screen 103 is a virtual character 106, which is produced by the system of the present invention. The virtual character 106 would interact with the live person image 105 in real-time.

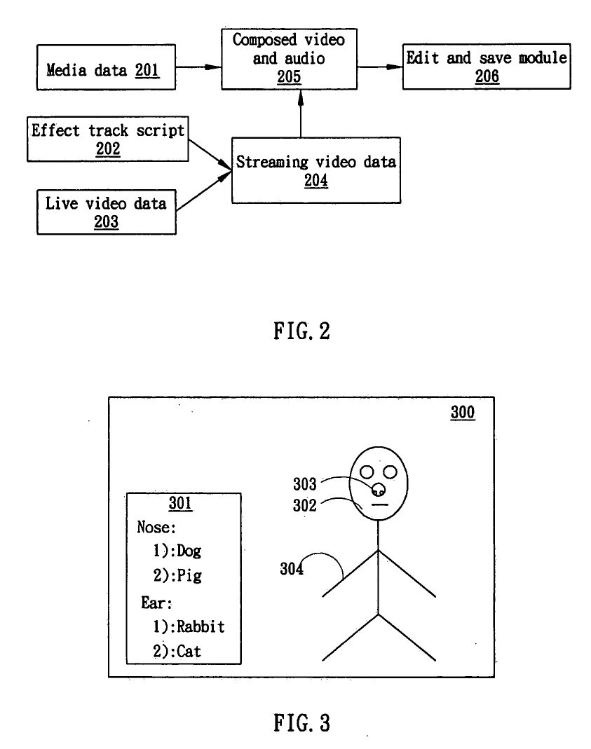

FIG. 2 shows the manipulation of the file structure according to one embodiment of the present invention. In this embodiment, the media data block 201 provides multimedia objects, such as virtual character, cartoon character, elves, cartooned eyes, animal nose, animal ear, animations, video, audio or interactive questions. Users could pre-determine and choose the virtual objects recorded in the media data 201.

Furthermore, the effect track scripts block 202 provides the special effect or the motion of the multimedia objects of the media data 201. In present embodiment, the effect track scripts 202 contain some basic information such as time parameters, space parameters, effect types, or applied targets, which are programmed by a specific computer language, and then saved as script files. The live video data block 203 contains the live person image captured by the capture module 102 as discussed above. The live video data 203 is then integrated with the pre-determined effect track script, resulting in the streaming video data 204, which is then further combined with the pre-determined media data 201 to produce the composed video and audio 205.

The composed video and audio 205 is subsequently input to an edit and save module 206, which provides users means to edit and save the composed video and audio 205 if needed. Specifically, the edit and save module 206 provides users means, for example, to add art treatment such as charcoal drawing and oil painting, to the composed video and audio 205. The users are allowed to pre-determine the saving mode for the composed video and audio 205, for example, saving the composed video and audio 205 during a specific interval, saving the composed video and audio 205 at specified intervals, saving the composed video and audio 205 according to users' choice, or saving all the composed video and audio 205.

The users could design different themes based on their gender, age, hobby, etc. Furthermore, the different themes could be collocated from different media data and effects. For example, a user could choose and download the desired virtual objects and music from the media data 201 while designing a theme, and then download the corresponding effects from the effect track scripts 202. Regarding a theme of an interactive questioning/answering, for example, the different answer which the user chooses will lead to a different reaction, in terms of different virtual objects, virtual characters, video, audio, effects, etc.

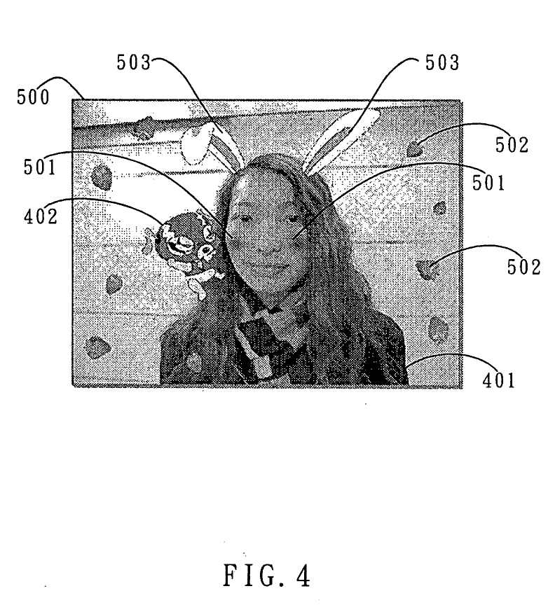

FIG. 3 shows an exemplary schematic illustrating that a chosen virtual object is superimposed on the face portion 302 of the live person image. A capture device (102 of FIG. 1) captures a live person image 304, which is shown on the display screen 300 in real-time. Users could enable an interface menu 301 by an input device such as keyboard before starting the recording process or during the recording process, and then choose a virtual object to be superimposed on the face portion 302 of the live person image through the interface menu 301. In this example, the user chooses a pig nose 303 as a desired virtual object. As shown in FIG. 3, the chosen pig nose 303 is superimposed on the nose portion of the live person image 304, and the pig nose 303 will subsequently follow the motion of the live person image 304. Specifically, the nose portion of live person image 304 is firstly recognized by using conventional recognition technique, and then the location and the motion of the nose is being continuously tracked by using tracking techniques as the nose portion of live person image 304 is replaced with the virtual object (i.e., the pig nose). Accordingly, the interaction between the live person and the virtual object is attained by continuously repeating the recognition and tracking.

According to another example (not shown) of the present invention, the interface menu 301 on the display screen 300 could show a question and several corresponding answers. Users choose an answer by the keyboard, and then the corresponding reaction will be shown on the display screen 300 based on the chosen answer to reach the interaction between the users and the question.

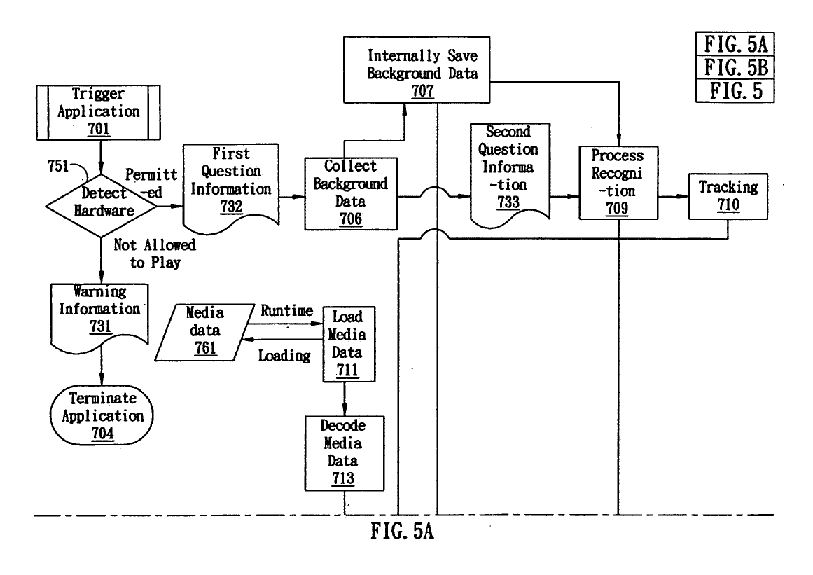

FIG. 4 shows another example illustrating how a live person interacts with a virtual object in real-time. The frame 500 of the display screen, which is captured by a capture device, contains a live person image 401. After executing the program in present embodiment, virtual objects such as portrayal, deity image, cartoon character, demons or ghosts are produced in its default mode. In this example, a virtual character 402 is produced.

Thereafter, the virtual character 402 will interact with the live person image 401 as shown in the frame 500. Referring again to FIG. 4, the virtual character 402 could have many provided effects, and the live person image 401 could probably have some slight motion such as leftward vor rightward movement. In the present embodiment, the virtual character 402 climbs on the shoulder of the live person image 401 and then kisses the cheeks of the live person image 401. Corresponding to the action of the virtual character 402, a blush effect 501 is performed on the cheeks of the live person image 401. In another instance, the virtual character 402 performs magic tricks to the live person image 401, and accordingly, the fruit icon 502 and the rabbit ears 503 are produced. The rabbit ears 503 are atop the head of the live person image 401. When the head of the live person image 401 moves slightly, the rabbit ears 503 will follow the movement. Particularly, the virtual character 402, live person image 401 and all effects interacts with each other in a real-time manner.

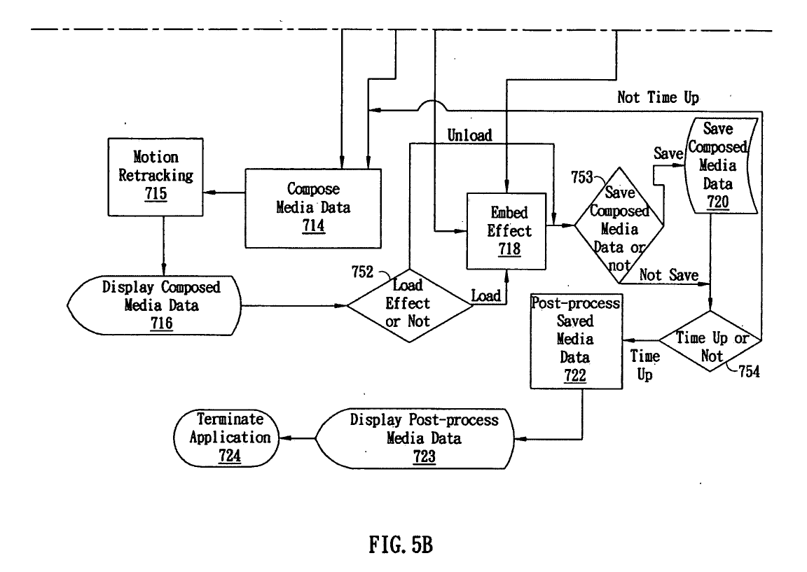

FIG. 5 shows a flow chart according to one embodiment of the present invention, illustrating the steps of the interaction between the live person image and the media data, the recording procedure, and the post-processing and saving the composed media data according to the users' demand.

At first, the system activates to trigger an application program 701, and then detects the hardware (step 751). A warning information 731 is issued if the hardware has some problems, followed by terminating the application program (step 704). The warning information 731 is used to alert users that the hardware is either not set up or not operable. For instance, the camera having not yet been installed, or the camera being uncompleted installed will cause such warning. If there is no problem detected during the step 751, a first request information 732 is issued. The first information 732 is displayed to prompt users to leave the capture scene of the camera for a while, so that the subsequent background data collection step 706 could be performed.

The background data collection step 706 is performed to collect or gather the background data in order to differentiate between the live person image and background, and the background data is then internally saved in the step 707. In the subsequent steps, the background data is used to eliminate the background portion of the image captured by the camera. The second request message 733 is displayed to prompt the users to enter the capture scene of the camera. Next, the recognition in step 709 is performed to recognize the face and limbs of the users, and the tracking in step 710 is performed to detect the motion of the face and the limbs of the users.

Moreover, the media data 761 containing multimedia, such as text, photograph, audio, video or animation, is prepared. After the system is activated, the media data is loaded (step 711) and is then decoded (step 713). And then, in step 714, the media data 761 and the live person image are integrated to obtain composed media data.

Thereafter, a motion retracking step 715 is performed to update any recently occurred variation about the live person image, and the composed media data is displayed (step 716). Afterwards, a determination is made about whether the special effect is to be loaded (step 752). If the answer is yes, an embed effect step 718 is performed; otherwise, the embed effect 718 step is skipped. The embed effect step 718 is performed to embed the basic information from the effects to the media data. Next, another determination is made about whether the composed media data is to be saved (step 753). If the answer is yes, the composed media data is saved (step 720); otherwise, the step is skipped.

A further determination is made about whether a predetermined time is up (step 754). If time is up, some post-processes are performed and the media data is saved (step 722), the post-processed media data is then displayed (step 723), and finally the whole application is terminated (step 724). If the time is not up yet, it is branched back to the step 714 to obtain further composed media data.

Specifically, it is worth noting that, in the case that time is not up, the following steps make an executing loop: the media data composing step 714, the motion retracking step 715, the composed media data displaying step 716, the effect loading determination step 752, the embed effect step 718, the determination step 753, the composed media data saving step 720, time up determination step 754. In this loop, present system keeps tracking the motion of the live person image, and then updates the position of media data to carry out the interaction in real time.

Furthermore, in the post-processing and media data saving step 722, art treatment, for example, is added to the media data not necessarily in a real-time manner. For example, the media data adds some specific art effect such as charcoal drawing effect, oil painting effect, or woodcut effect.

Moreover, in the post-processing and media data saving step 722, users could also determine the saving mode for the media data, for example, saving the media data during a specific interval, saving the media data at specified intervals, saving the media data according to the users' choice, or saving all the media data. The file format for saving the media data could be the Bitmap (BMP) format, the Graphics Interchange Format (GIF), the Windows Media Video (WMV), or other appropriate format.

The embodiment discussed above could be performed through personal computers (PCs), laptop computers, set-top boxes, game consoles, or even mobile phones. For example, two users connected via the Internet could choose a virtual character for himself/herself or the other side, and control the virtual character to perform different effects. Finally, the result would be displayed on both the local screen and the screen at the other side.

Although specific embodiments have been illustrated and described, it will be obvious to those skilled in the art that various modifications may be made without departing from what is intended to be limited solely by the appended claims.

1. A method for producing real-time interactive video and audio, said method comprising:
capturing an object image from an object;
displaying said object image on a screen;
providing a plurality of selectable items on said screen, wherein each said item corresponds to at least a multimedia object;
displaying said corresponding multimedia object according to the item that is selected;
continuously recording content that includes interaction between said object image and the corresponding multimedia object; and
saving said content.

2. The method according to claim 1, wherein said multimedia object is an element selected from the group consisting of text, photograph, audio, video, animation, and combination thereof.

3. The method according to claim 1, wherein said multimedia object follows the motion of said object image.

4. The method according to claim 1, further comprising detecting motion of said object image.

5. The method according to claim 1, further comprising tracking said object image.

6. The method according to claim 1, further comprising adding an effect image on said object image.

7. The method according to claim 6, further comprising generating at least an effect script for said effect image.

8. The method according to claim 6, further comprising choosing said interaction from one of the effect scripts.

9. The method according to claim 1, wherein said step of saving the content is determined from one of following modes:
saving the content during a specific interval;
saving the content at specified intervals;
saving the content according to a user's choice; and
saving all of the content.

10. The method according to claim 1, further comprising adding art treatment to the content.

11. A computer-readable medium for storing a program which performs following steps comprising:
capturing an object image from an object;
displaying said object image on a screen;
providing a plurality of selectable items on said screen, wherein each said item corresponds to at least a multimedia object;
displaying the corresponding multimedia object according to the item that is selected;
continuously recording content that includes interaction between said object image and the corresponding multimedia object; and
saving said content.

12. The medium according to claim 11, wherein said program further comprises detecting motion of said object image.

13. The medium according to claim 11, wherein said program further comprises tracking said object image.

14. The medium according to claim 11, wherein said program further comprises adding an effect image on said object image.

15. The medium according to claim 11, wherein said program further comprises generating at least an effect script for said effect image.

16. A system for producing real-time interactive video and audio, said system comprising:
a display device including a screen;
a computing device including at least a processor, a memory and a program that includes at least a multimedia object and at least an effect script;
a capture device for capturing an image, wherein said image is then integrated with said multimedia object by said effect script to generate a composed media data to be displayed on the screen; and
means for saving said composed media data.

17. The system according to claim 16, wherein said multimedia object is an element selected from the group consisting of text, photograph, audio, video, animation, and combination thereof.

18. The system according to claim 16, wherein said saving means is further for processing said composed media data by an art treatment.

19. The system according to claim 16, wherein said saving means has one of following modes:
saving the composed media data during a specific interval;
saving the composed media at specified intervals;
saving the composed media data according to a user's choice; and
saving all of the composed media data.
